(19) United States
(12) Patent Application Publication
(10) Pub. No.: US 2025/0272150 A1
(43) Pub. Date: Aug. 28, 2025

(54) GENERATING AI-BASED COLLABORATION METHOD AND SYSTEM

(71) Applicant: SAMSUNG SDS CO., LTD., Seoul (KR)

(72) Inventors: Bo Young PARK, Seoul (KR); Young Hyun CHOI, Seoul (KR); Ji Yeon LEE, Seoul (KR); Da Gun LEE, Seoul (KR); In Pyo KIM, Seoul (KR)

(73) Assignee: SAMSUNG SDS CO., LTD., Seoul (KR)

(21) Appl. No.: 19/065,777

(22) Filed: Feb. 27, 2025

(30) Foreign Application Priority Data
Feb. 28, 2024 (KR) 10-2024-0028494
May 23, 2024 (KR) 10-2024-0066970

(51) Int. Cl. G06F 9/50

(52) U.S. Cl. CPC G06F 9/5027

(57) ABSTRACT

Provided is a method performed by at least one computing system. The method may comprise receiving a user request regarding a target task from a user terminal, determining a task set required to process the target task by inputting the user request into a generative model, the task set including a plurality of tasks performed through a plurality of applications, requesting a corresponding task to be performed for each of the plurality of applications; and providing a plurality of contents generated through each of the plurality of applications to the user terminal according to the task performance request.

### CROSS-REFERENCE TO RELATED APPLICATIONS

This application claims priority from Korean Patent Application No. 10-2024-0028494 filed on Feb. 28, 2024, and Korean Patent Application No. 10-2024-0066970 filed on May 23, 2024, in the Korean Intellectual Property Office, and all the benefits accruing therefrom under 35 U.S.C. 119, the contents of which in its entirety are herein incorporated by reference.

### BACKGROUND

### Technical Field

The present disclosure relates to a method and system for processing a task based on generative AI, and more particularly, to a method for processing a plurality of tasks required to perform a target task using a generative model through a plurality of corresponding applications, and a system to which the method is applied.

### Description of the Related Art

Recently, the use of generative AI-based virtual assistants to perform tasks has been increasing. For example, the virtual assistant may receive user input and perform a variety of tasks based on the user input, such as writing a document or drafting an email.

However, since the virtual assistant may only assist with the tasks performed in a single application, there are limitations to the use of the virtual assistant when performing the tasks through a plurality of applications or sharing and utilizing data across the plurality of applications.

Accordingly, there is a demand for technology that may improve work efficiency by using a generative AI-based virtual assistant in an environment where the tasks are performed through the plurality of applications.

### RELATED ART DOCUMENT

### Patent Document

US Patent Laid-Open Publication No 2024-0020593 (published on Jan. 18, 2024)

### SUMMARY

Aspects of the present disclosure provide a method and system for processing a task that support effective performance of the task through a plurality of applications using generative AI.

Aspects of the present disclosure also provide a method and system capable of improving accuracy and efficiency of task processing by accurately determining a plurality of tasks required to process a target task according to a user input.

Aspects of the present disclosure also provide a method and system that support the performance of tasks through a plurality of applications using generative AI in a collaborative environment of a plurality of users.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some embodiments of the present disclosure, by easily performing the plurality of tasks performed through the plurality of applications with a single user input, task efficiency and resulting task satisfaction may be significantly improved.

Further, by determining the task set required to process a target task based on the user input and context information, the accuracy of task processing may be effectively improved.

In addition, by supporting task execution through the plurality of applications in an environment where a plurality of users collaborate, collaboration efficiency may be significantly improved.

Effects according to the technical idea of the present disclosure are not limited to the effects mentioned above, and other effects that are not mentioned may be obviously understood by those skilled in the art from the following description.

According to an aspect of the present disclosure, there is provided method for processing a task based generative AI, performed by at least one computing system. The method may comprise receiving a user request regarding a target task from a user terminal, determining a task set required to process the target task by inputting the user request into a generative model, the task set including a plurality of tasks performed through a plurality of applications, requesting a corresponding task to be performed for each of the plurality of applications; and providing a plurality of contents generated through each of the plurality of applications to the user terminal according to the task performance request.

In some embodiments, the determining of the task set may include obtaining context information associated with the user request, configuring a prompt for determining the task set based on the user request and the context information and determining the task set by inputting the prompt into the generative model.

In some embodiments, the context information may include task history information associated with a user of the user terminal.

In some embodiments, the context information may include information about an activated application in the user terminal.

In some embodiments, the requesting of the corresponding task to be performed may include generating a task performance request message for each of the plurality of tasks and transmitting the task performance request message to a corresponding application.

In some embodiments, the requesting of the corresponding task to be performed may include determining a task performance order based on a correlation between the plurality of tasks, sequentially generating a task performance request message based on the task performance order and sequentially transmitting the task performance request message to a corresponding application.

In some embodiments, the generating of the task performance request message may include generating a first task performance request message for a first application and generating a second task performance request message for a second application using a first content generated through the first application based on the first task performance request message.

In some embodiments, the requesting of the corresponding task to be performed may include providing information about the determined task set to the user terminal and requesting a corresponding task to be performed for each of the plurality of applications to perform a corresponding task, when a request to proceed with the task set is received from the user terminal.

In some embodiments, the providing of the plurality of contents to the user terminal may further include receiving a modification request for at least one of the plurality of contents from the user terminal, transmitting a modification request message for performing a modification task according to the modification request to an application associated with the modification request and providing modified content to the user terminal based on the modification request message.

According to another aspect of the present disclosure, there is provided method for processing a task based generative AI, performed by at least one computing system. The method may comprise receiving a plurality of user requests regarding a target task from a plurality of user terminals corresponding to each of a plurality of users of a user group for performing a joint task, determining a task set for performing the target task based on the plurality of user requests, the task set including a plurality of tasks performed through a plurality of applications, requesting a corresponding task to be performed for each of the plurality of applications and providing a plurality of contents generated from each of the plurality of applications based on the task performance request to each of the plurality of user terminals.

In some embodiments, the plurality of user terminals may include a first user terminal, and the receiving of the plurality of user requests may include receiving a first user request from the first user terminal and transmitting the first user request to remaining user terminals except for the first user terminal.

In some embodiments, the receiving of the plurality of user requests may include checking user authentication information corresponding to the plurality of user terminals and determining whether to receive the plurality of user requests based on the check result.

In some embodiments, the determining of the task set may include obtaining context information associated with the plurality of user requests, configuring a prompt for determining the task set based on the plurality of user requests and the context information; and determining the task set by inputting the prompt into the generative model.

According to another aspect of the present disclosure, there is provided a system for processing a task based generative AI. The system may include one or more processors and a memory configured to store one or more computer programs executed by the one or more processors, wherein the one or more computer programs include instructions for: an operation of receiving a user request regarding a target task from a user terminal, an operation of determining a task set required to process the target task by inputting the user request into a generative model, the task set including a plurality of tasks performed through a plurality of applications, an operation of requesting a corresponding task to be performed for each of the plurality of applications and an operation of providing a plurality of contents generated through each of the plurality of applications to the user terminal according to the task performance request.

In some embodiments, the operation of determining the task set may include: an operation of obtaining context information associated with the user request, an operation of configuring a prompt for determining the task set based on the user request and the context information and an operation of determining the task set by inputting the prompt into the generative model.

In some embodiments, the operation of requesting the corresponding task to be performed may include: an operation of generating a task performance request message for each of the plurality of tasks and an operation of transmitting the task performance request message to a corresponding application.

In some embodiments, the operation of requesting the corresponding task to be performed may include: an operation of determining a task performance order based on a correlation between the plurality of tasks, an operation of sequentially generating a task performance request message based on the task performance order and an operation of sequentially transmitting the task performance request message to a corresponding application.

In some embodiments, the operation of generating the task performance request message may include: an operation of generating a first task performance request message for a first application and an operation of generating a second task performance request message for a second application using a first content generated through the first application based on the first task performance request message.

In some embodiments, the operation of requesting the corresponding task to be performed may include an operation of providing information about the determined task set to the user terminal and an operation of requesting a corresponding task to be performed for each of the plurality of applications to perform a corresponding task, when a request to proceed with the task set is received from the user terminal.

In some embodiments, the operation of providing the plurality of contents to the user terminal may further include: an operation of receiving a modification request for at least one of the plurality of contents from the user terminal, an operation of transmitting a modification request message for performing a modification task according to the modification request to an application associated with the modification request and an operation of providing modified content to the user terminal based on the modification request message.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram exemplarily illustrating a configuration of an entire system in which a system for processing a task according to an embodiment of the present disclosure operates;

FIG. 2 is a diagram exemplarily illustrating an operating environment according to the system for processing a task illustrated in FIG. 1;

FIG. 3 is a diagram exemplarily illustrating a configuration of an entire system in which a system for processing a task according to another embodiment of the present disclosure operates;

FIG. 4 is a diagram exemplarily illustrating an operating environment according to the system for processing a task illustrated in FIG. 3;

FIG. 5 is a flowchart illustrating a method for processing a task based on generative AI according to still other embodiments of the present disclosure;

FIGS. 6 to 9B are exemplary diagrams for describing some operations illustrated in FIG. 5;

FIG. 10 is an exemplary diagram for describing a modified example of some operations illustrated in FIG. 5;

FIG. 11 is a flowchart illustrating a method for processing a task based on generative AI according to still other embodiments of the present disclosure;

FIGS. 12A-12D are exemplary diagrams for describing some operations illustrated in FIG. 11; and

FIG. 13 is a block diagram illustrating a hardware configuration of a computing system for performing the method for processing the task based on the generative AI according to some embodiments of the present disclosure.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

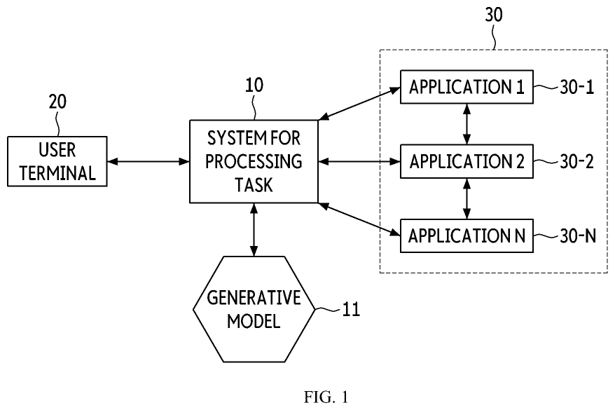

FIG. 1 is a diagram exemplarily illustrating a configuration of an entire system in which a system for processing a task according to an embodiment of the present disclosure operates.

As illustrated in FIG. 1, a system 10 for processing a task according to an embodiment of the present disclosure may implement a method for processing a task according to an embodiment of the present disclosure through interaction with a user terminal 20 and a plurality of applications 30-1, 30-2, . . . , and 30-N. In this case, the system 10 for processing the task may provide a response (content) according to a user request in conjunction with a generative model 11. Here, the generative model 11 may include a Large Language Model (LLM) with natural language (text) understanding and generation capabilities, and a vision language model (or Large Multimodal Model (LMM)) further with image understanding capabilities, and may also include understanding capabilities for other modals. The generative model 11 may also be either a self-developed model or a model provided externally. In some cases, the generative model 11 may also be named ‘Language Model (LM)’, ‘Large Language Model (LLM)’, ‘Generative Language/Deep Learning Model’, or ‘Generative Artificial Intelligence (AI) Model’. In addition, in some cases, the system 10 for processing the task may also be named ‘copilot’, ‘super-copilot’, ‘task assistant’, or ‘task agent’.

The user may input a user request to be transmitted to the system 10 for processing the task through a user terminal 20, i.e., through a user interface provided by the system 10 for processing the task. The user interface may include both a graphical user interface (GUI), such as a dialog box for user request input and a search box, and an application interface, such as a Rest API. Here, the user request may be in various forms such as text, voice, image, video, etc., and may be a prompt including a description of the target task. In some cases, the user request may further include information, such as a set of tasks needed to process the target task, an application to perform the set of tasks, etc.

According to an embodiment of the present disclosure, the system 10 for processing the task may understand the user request using the generative model 11 and perform a target task based on the understood content. Specifically, the system 10 for processing the task may identify and determine a task set required to process the target task by understanding the user request through the generative model 11. Here, the task set means a collection of tasks associated with processing the target task, and the task set may be configured to include a plurality of tasks. Here, the task means any task or job that may be performed through a specific application. Examples of the task may include, but are not limited to, “Write a draft of an email using a mail application” or “Write a draft of a report using a word processing application.” In an embodiment, the plurality of tasks included in the task set may mean tasks performed through different applications. The process of identifying and determining the task set required to process the target task will be described later.

The system 10 for processing the task may request that the plurality of tasks included in the task set be performed, and may provide content generated through each of the plurality of applications 30 to the user terminal 20. To this end, a plug-in for each application for controlling the plurality of applications 30-1, 30-2, . . . , and 30-N may be installed in the system 10 for processing the task.

The application 30 is a program or system designed to perform a specific task on the user terminal 20. The application 30 may be a general-purpose business system such as, for example, an email application, a messenger application, a task management and project collaboration application, a calendar application, a document creation and editing application, etc. In another example, the application 30 may be a specialized application that provides functions required for task in the relevant field in finance, manufacturing, and other specialized domains. The application 30 may interact with other applications through API linkage.

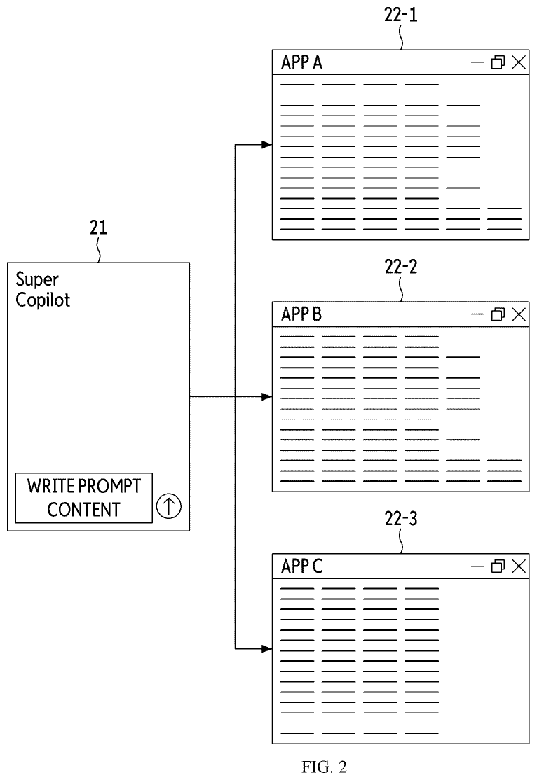

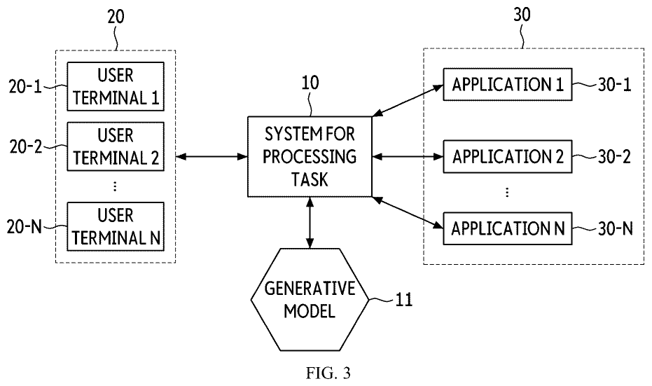

In summary, according to an embodiment of the present disclosure, when a user request regarding a target task is input through a single user interface provided by the system 10 for processing the task, a plurality of tasks required to process the target tasks may be simultaneously (or sequentially) performed through the plurality of applications. For example, as illustrated in FIG. 2, when a prompt regarding a target task is input through a single user interface 21 provided by the system 10 for processing the task, a plurality of tasks required to process the target task may be performed through a plurality of applications App A, App B, and App C, and a screen including the results (contents) 22-1, 22-2, and 22-3 may be provided to the user terminal.

According to another embodiment of the present disclosure, the system 10 for processing the task may also perform target tasks according to user requests input through a plurality of user terminals.

FIG. 3 is a diagram exemplarily illustrating a configuration of an entire system in which a system for processing a task according to another embodiment of the present disclosure operates.

As illustrated in FIG. 3, a system 10 for processing a task according to the present embodiment may implement a method for processing a task according to the present embodiment through interaction with a plurality of user terminals 20-1, 20-2, . . . , and 20-N and a plurality of applications 30-1, 30-2, . . . , and 30-N. Since the entire system according to the present embodiment differs from the configuration of the entire system described with reference to FIG. 1 in that it may interact with the plurality of user terminals, such a difference will be mainly described below.

The system 10 for processing the task according to the present embodiment may provide a collaborative environment in which users of the plurality of user terminals 20-1, 20-2, . . . , and 20-N may communicate in real time, share data, and perform collaboration. A plurality of users of a user group for performing joint task may request access to the collaborative environment through the user terminals, and the system 10 for processing the task may determine whether to allow an access request by identifying a user terminal associated with the access request and checking corresponding user authentication information.

The system 10 for processing the task may provide an environment in which user inputs received from the plurality of user terminals may be shared. For example, when a first user inputs a first user request through a first user terminal, the system 10 for processing the task may transmit the first user request to user terminals associated with the remaining users except for the first user. Accordingly, user requests and prompt contents input by the plurality of users on their respective user terminals may be shared by all of the plurality of users. In this case, the plurality of users, i.e., the plurality of user terminals, may be users set as a user group for performing the joint task.

The system 10 for processing the task may identify and determine a task set required to process the target task by understanding the user request using the generative model 11, as in the previous embodiment. In addition, the system 10 for processing the task may request execution of a task corresponding to each of the plurality of applications 30 for performing the plurality of tasks included in the task set. To this end, a plug-in for each application for controlling the plurality of applications 30-1, 30-2, . . . , and 30-N may be installed in the system 10 for processing the task, and the system 10 for processing the task may request the execution of the task for the corresponding application through an API call, etc. In addition, the system 10 for processing the task may provide a plurality of contents generated from each of the plurality of applications to each of the plurality of user terminals based on the task execution request.

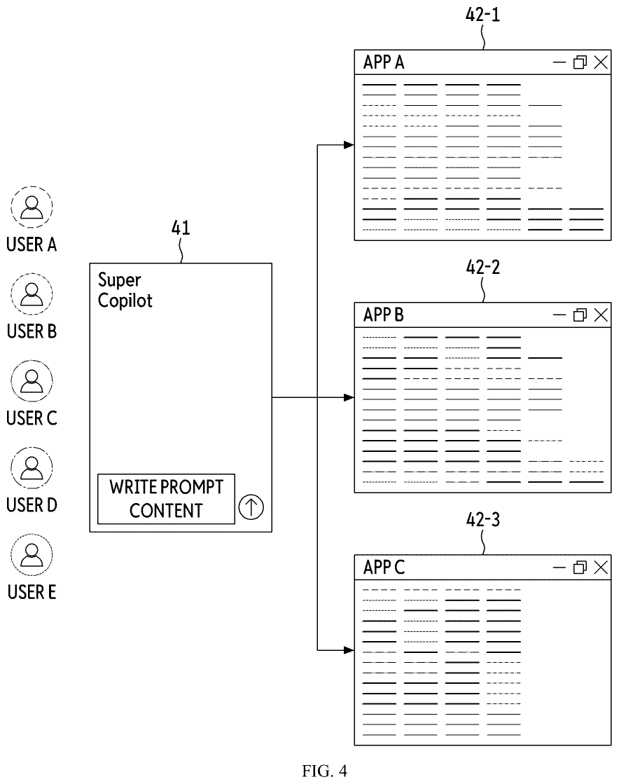

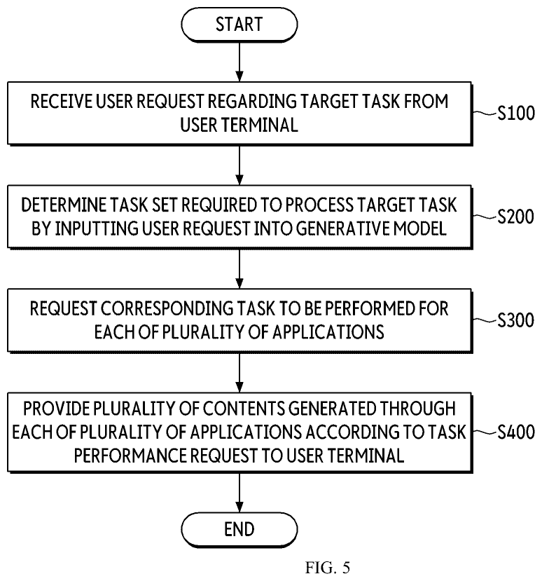

In summary, according to the present embodiment, the plurality of users may input the user request through the plurality of user terminals, and the plurality of tasks required to process the target task based on the user request input from the plurality of user terminals may be simultaneously (or sequentially) performed through the plurality of applications. For example, as illustrated in FIG. 4, a plurality of users (User A, User B, User C, User D, and User E) may input a prompt regarding the target task through a user interface 41 provided by the system 10 for processing the task, a plurality of tasks may be performed through a plurality of applications (App A, App B, and App C) based on the input prompt, and a screen including the corresponding results (contents) 42-1, 42-2, and 42-3 may be provided for each of the plurality of user terminals.

Hereinabove, the configuration and operation of the system 10 for processing the task according to some embodiments of the present disclosure have been described with reference to FIGS. 1 and 4. The embodiments described above may be understood in more detail with reference to other embodiments described later. In addition, the technical ideas that may be understood through the embodiments described above may be applied to other embodiments described later even if not specifically stated otherwise.

Hereinafter, a method for processing a task based on generative AI according to another embodiment of the present disclosure will be described with reference to FIGS. 5 to 10. It may be understood that the steps described in the following flowcharts are performed by the system 10 for processing the task described with reference to FIG. 1 unless otherwise stated. However, for convenience of explanation, the description of the operation subject of each step may also be omitted.

FIG. 5 is a flowchart illustrating a method for processing a task based on generative AI according to some embodiments of the present disclosure. However, this is only a preferred embodiment for achieving the object of the present disclosure, and some steps may also be added or deleted as needed.

As illustrated in FIG. 5, a method for processing a task based on generative AI according to an embodiment of the present may start at step S100 of receiving a user request regarding a target task from a user terminal. Specifically, a user may input a user request including a description of a target task to be processed through a user terminal, and the user request may be transmitted to the system 10 for processing the task. Here, the user request may be data in text form, but the present disclosure is not limited thereto, and the user request may also be configured in various data forms such as voice, image, video, etc. The user request may be in the form of a clearly defined task required to process (solve) a target task, such as, for example, “Plan today's work schedule, assign work personnel based on the work schedule, and organize the work progress.” In another example, the user request may also be in the form of an unclearly defined task required to solve a specific problem (situation) (target task), such as “I have a problem with my work schedule. Please take all actions necessary to resolve the problem.”

In step S200, a task set required to process the target task may be determined by inputting the user request into a generative model. Specifically, the system 10 for processing the task may identify a target task based on the user request in conjunction with the generative model 11, and may determine a task set including a plurality of tasks required to process the target task. In this case, the plurality of tasks may mean arbitrary works that may be performed through different applications. For example, the plurality of tasks may include a schedule change task through a schedule management system, a message composition task through a messenger application, a document creation task through a document creation application, etc.

According to an embodiment, a prompt for determining the task set may be configured based on user request and context information, and the task set required to process the target task may be determined by inputting the prompt into the generative model 11. To this end, first, context information associated with the user request may be obtained. Here, the context information refers to a set of information that needs to be considered to determine the task set. The context information may include, for example, user information of the user terminal (user job information, work information defined by the user, etc.), task history information associated with the user of the user terminal (information about the work the user is in charge of, work history information recently performed by the user, information about the user's work pattern (flow), etc.), task history information associated with the target task (task set determination information according to a request from a user different from the user of the user terminal, task performance history information, etc.), and the like. In another example, the context information may include information associated with a current state of the user terminal, such as information about a currently activated application, in the user terminal.

In an embodiment, the number of contextual information used to construct the prompt for determining the task set may be designed in various ways. For example, when the target task corresponds to a regularly repeated task, only one piece of previous task history information may be included in the context information. Accordingly, it is possible to easily resolve a problem such as long processing times due to a large number of past task histories and a problem such as a recently updated work method not being reflected. In another example, when the target task corresponds to a task according to a specific event, a plurality of task history information associated with similar events may be included in the context information.

Next, in step S300, a corresponding task may be requested to be performed for each of the plurality of applications. Specifically, step S300 may include a step of generating a task performance request message for each of the plurality of tasks and a step of transmitting the task performance request message to a corresponding application. In this way, by generating the corresponding task performance request message for each application, the task to be performed by each application may be more accurately understood.

In an embodiment, the task performance requests may be sequentially performed. Specifically, the order of task performance may be determined based on the correlation between the plurality of tasks, the task performance request messages may be sequentially generated based on the order of task performance, and the generated task performance request messages may be sequentially transmitted to the corresponding applications. In this case, the task performance request message may be generated based on the task performance result of the previous order. For example, when the order of task performance is determined such that a first task is performed by a first application and then a second task is performed by a second application, a first task performance request message for the first application may be generated, and a second task performance request message for the second application may be generated using a first content (result) generated through the first application based on the first task performance request message.

In an embodiment, before the task is requested to be performed, user intervention for checking whether to proceed with the determined task set may be requested. Specifically, information about the determined task set may be provided to the user terminal, the user may check a task to be performed through the user terminal and application information corresponding to the task, may determine whether the task set is suitable, and may input request information regarding whether to proceed with the task set into the user terminal. When a request to proceed with the task set is received from the user terminal, a task performance request message requesting that requests the corresponding task performance for each of the plurality of applications may be generated. In this case, the user intervention request may be automatically performed based on the importance of the target task, familiarity of the target task, etc. For example, when the importance of the target task is a reference value or more, or the familiarity of the target task is less than the reference value, the user intervention may be automatically requested (i.e., the information about the determined task set may be provided to the user terminal), and the task performance request may be processed according to the received progress request. In another example, when the importance of the target task is less than the reference value, or the familiarity of the target task is the reference value or more, the request to perform the determined task may be immediately processed without requiring the user intervention.

Next, in step S400, a plurality of contents generated through each of the plurality of applications according to the task performance request may be provided to the user terminal. Specifically, when the task performance request message is received, the application may be executed, and as the corresponding task is performed through the application, each screen (window) including the generated results (content) may be displayed (provided) on a display of the user terminal. The user may check the generated content through the user terminal and request approval, modification, etc.

In an embodiment, step S400 may further include a step of transmitting a modification request message for performing a modification task according to a modification request to an application associated with the modification request when the modification request for at least one of the plurality of contents is received from the user terminal, and a step of providing content modified based on a modification request message to the user terminal. That is, the user may simultaneously check the contents generated through the plurality of applications through the user terminal, and may efficiently modify the contents generated through the plurality of applications by inputting the modification request into one user interface.

Hereinafter, the method for processing the task based on the generative AI according to the present embodiment will be described in more detail with reference to specific embodiments.

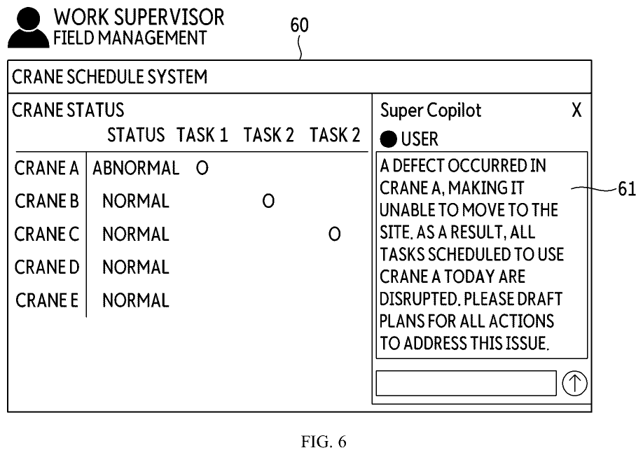

FIGS. 6 to 9 are exemplary diagrams for describing some operations illustrated in FIG. 5. More specifically, FIGS. 6 to 9 illustrate screens provided to the user terminal according to the method for processing the task according to the present embodiment.

FIG. 6 illustrates an example of a situation where a user (work supervisor) checks a crane status through a crane schedule system, finds that there is a defect in crane A, and instructs plans for actions to address the issue.

The user may execute a user interface (super copilot) 61 provided by the system 10 for processing the task on a screen 60 of a currently used system (application), and may input a user request regarding a target task into the user interface 61. For example, as illustrated in FIG. 6, the user may input a prompt for a target task, such as ‘Draft a plan of action for an emergency situation,’ such as “A defect occurred in Crane A, making it unable to move to the site. As a result, all tasks scheduled to use Crane A today are disrupted. Please draft plans for all actions to address this issue.”

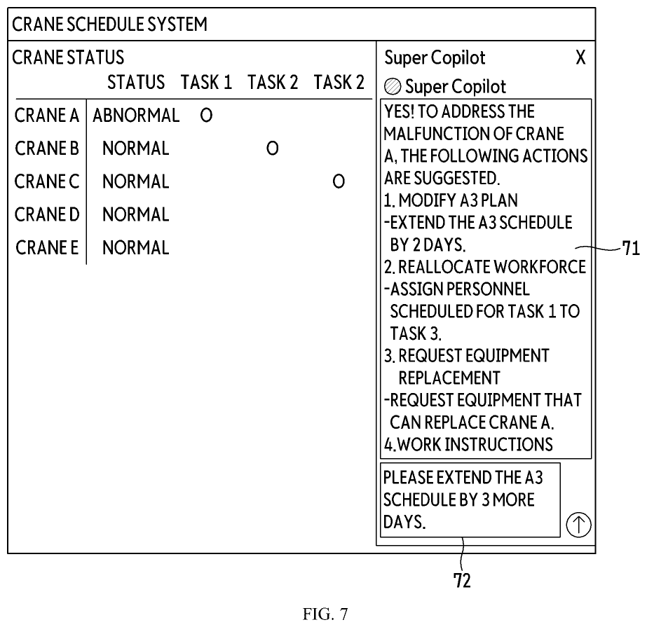

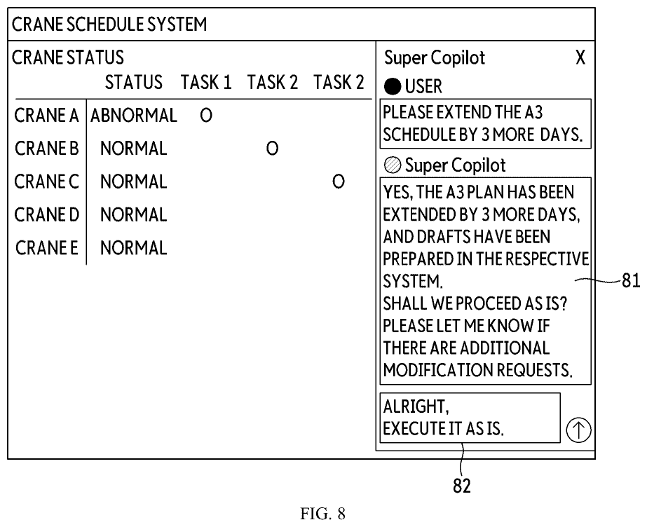

The system 10 for processing the task may determine a task set required to process the target task based on the user request and context information, and may provide information about the determined task set to the user terminal. As illustrated in FIG. 7, information 71 about the task set may be displayed as text in response to the user request on the user interface. The user may input a modification request such as “Please extend the A3 schedule by an additional 3 days,” into a prompt input window, and as illustrated in FIG. 8, information 81 regarding a modified task set in response to the modification request may be provided. The user may check the information 81 about the modified task set and input an execution request 82 of the determined task set. By checking the task set in this way and requesting modifications to some or all of the task sets, a more accurate task set that meets the user's needs may be determined.

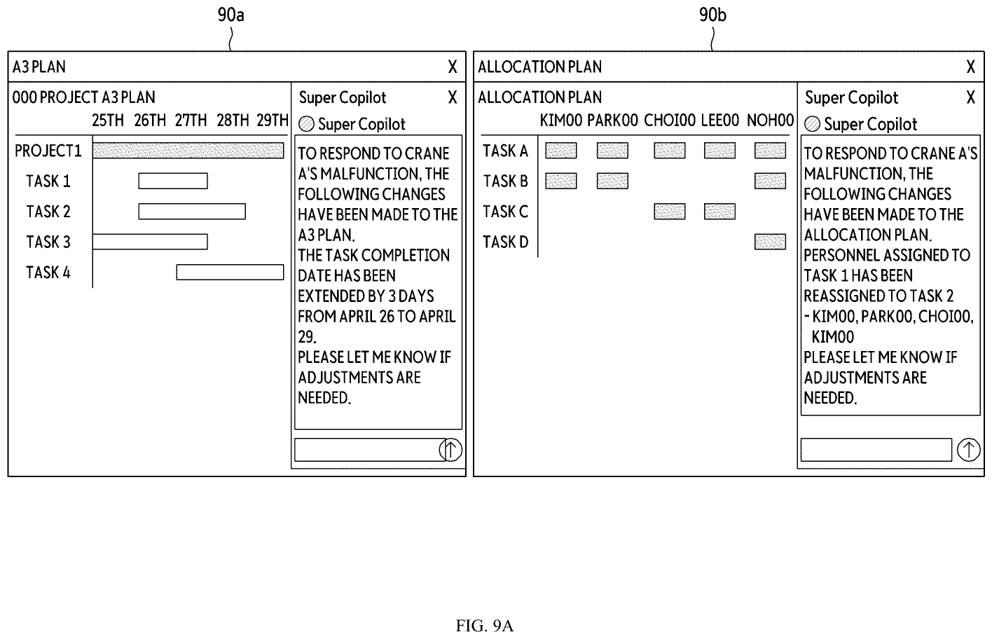

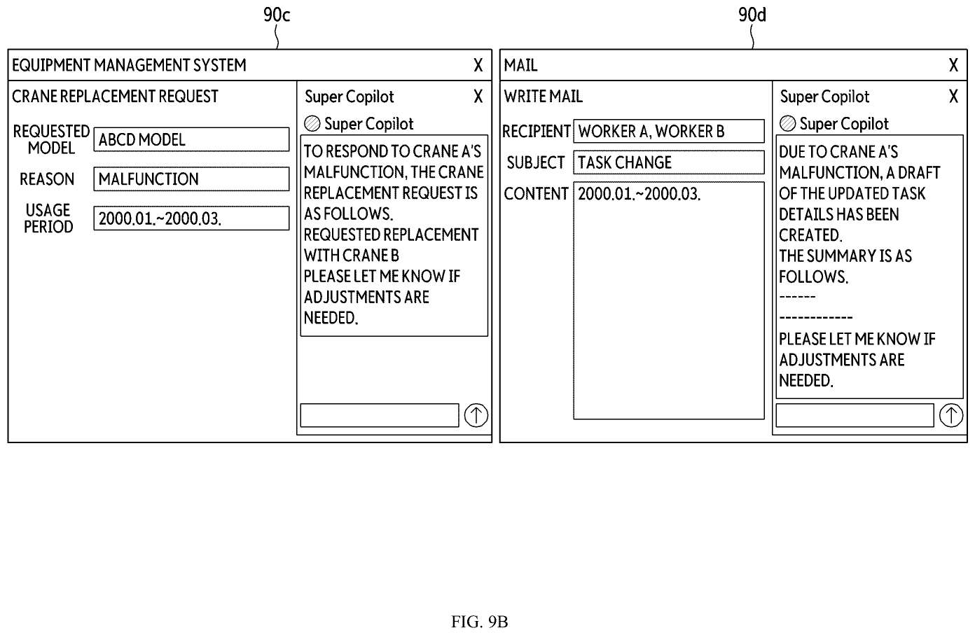

When the task set is determined as described above, the system 10 for processing the task may transmit a message requesting task performance to a corresponding application, and the task may be performed in each application based on the task performance request message. As the task is performed in each application, the generated content may be provided to the user terminal through screens 90a, 90b, 90c, and 90d of each application, as illustrated in FIG. 9A and FIG. 9B.

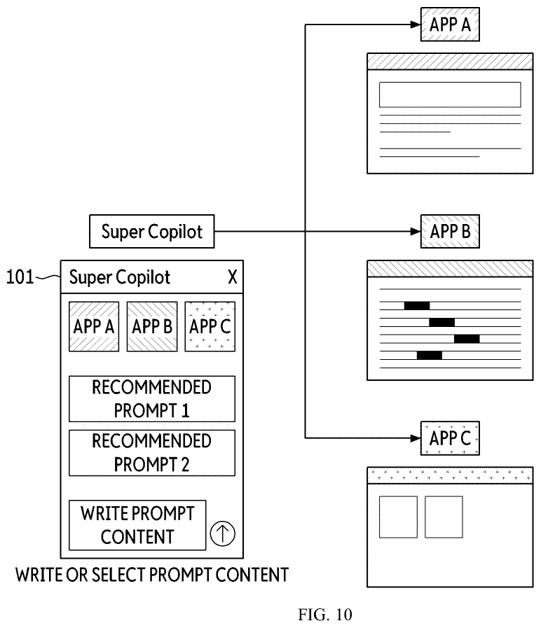

Unlike the previous embodiments, the application in which the task is to be performed may also be set (defined) by the user. For example, as illustrated in FIG. 10, target applications App A, App B, and App C for performing the tasks may be set (101) through the user interface, and When the target application is set, the task based on the prompt input by the user may only be performed through the target application.

Hereinabove, the method for processing the task based on the generative AI according to some embodiments of the present disclosure has been described with reference to FIGS. 5 to 10. As described above, by easily controlling the plurality of applications with a single user input, the plurality of tasks may be simultaneously performed, which may significantly improve work efficiency and user satisfaction.

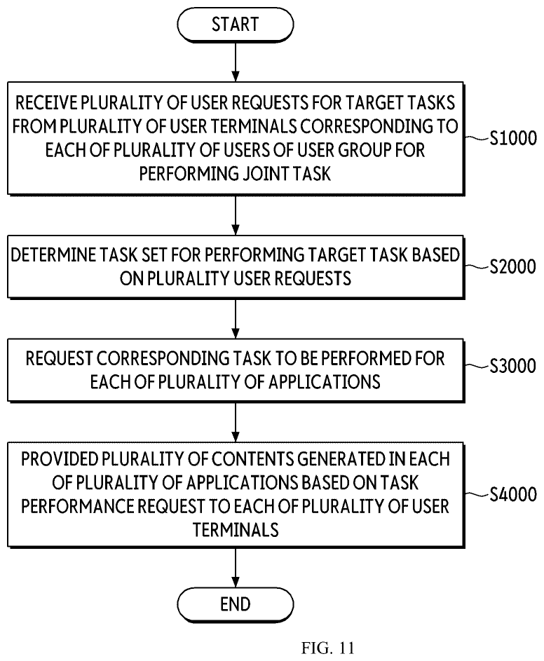

Hereinafter, a method for processing a task based on generative AI according to another embodiment of the present disclosure that supports task processing based on user requests by a plurality of users will be described with reference to FIG. 11. It may be understood that the steps described in the following flowcharts are performed by the system 10 for processing the task described with reference to FIG. 3 unless otherwise stated. However, for convenience of explanation, the description of the operation subject of each step may also be omitted.

FIG. 11 is a flowchart illustrating a method for processing a task based on generative AI according to another embodiment of the present disclosure. However, this is only a preferred embodiment for achieving the object of the present disclosure, and some steps may also be added or deleted as needed.

Referring to FIG. 11, in step S1000, a plurality of user requests for target tasks may be received from a plurality of user terminals corresponding to each of the plurality of users of a user group for performing a joint task. In this case, the user requests received from the plurality of user terminals may be transmitted to other user terminals. For example, when a first user request is received from a first user terminal, the first user request may be transmitted to the remaining user terminals except for the first user terminal. In an embodiment, whether to receive the user request may be determined based on user authentication results for the plurality of user terminals.

Next, in step S2000, a task set for performing the target task may be determined based on the plurality of user requests. In this case, the task set may include a plurality of tasks performed by the plurality of applications.

In an embodiment, the task set may be determined based on the plurality of user requests and the context information. Specifically, context information associated with the plurality of user requests may be obtained, and the task set may be determined by inputting a prompt for determining the task set to a generative model based on the plurality of user requests and the context information.

Next, in step S3000, a corresponding task may be requested to be performed for each of the plurality of applications, and a plurality of contents generated in each of the plurality of applications based on the task performance request may be provided to each of the plurality of user terminals (S4000).

Hereinafter, the method for processing the task based on the generative AI according to the present embodiment will be described in more detail with reference to specific embodiments.

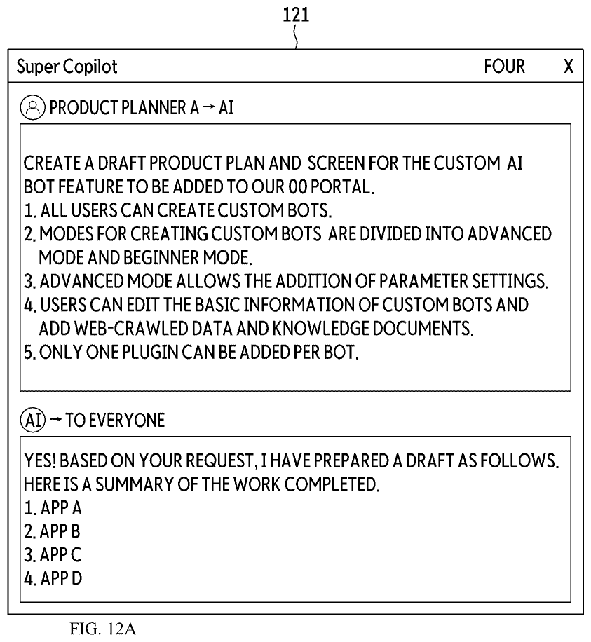

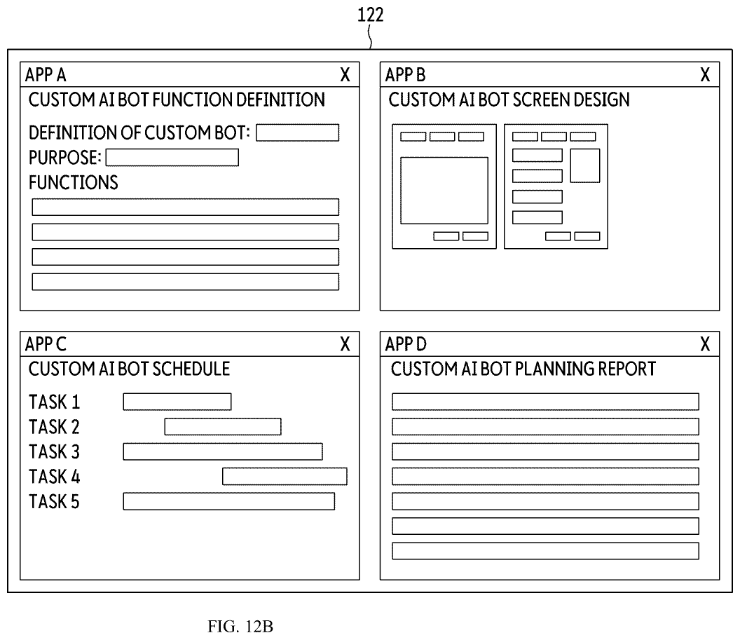

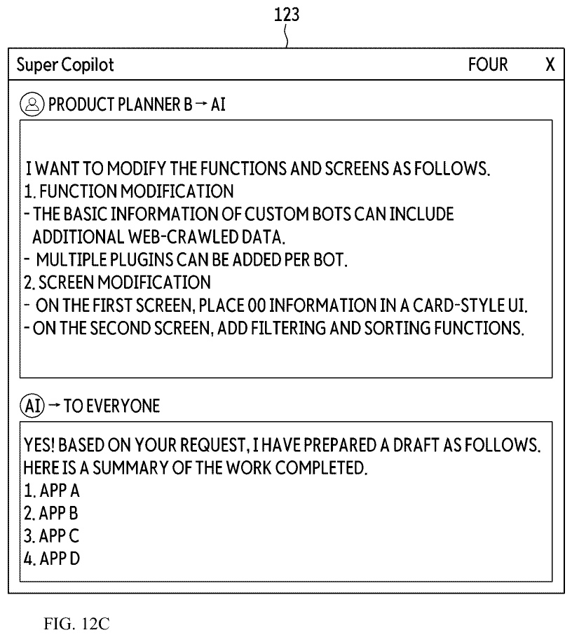

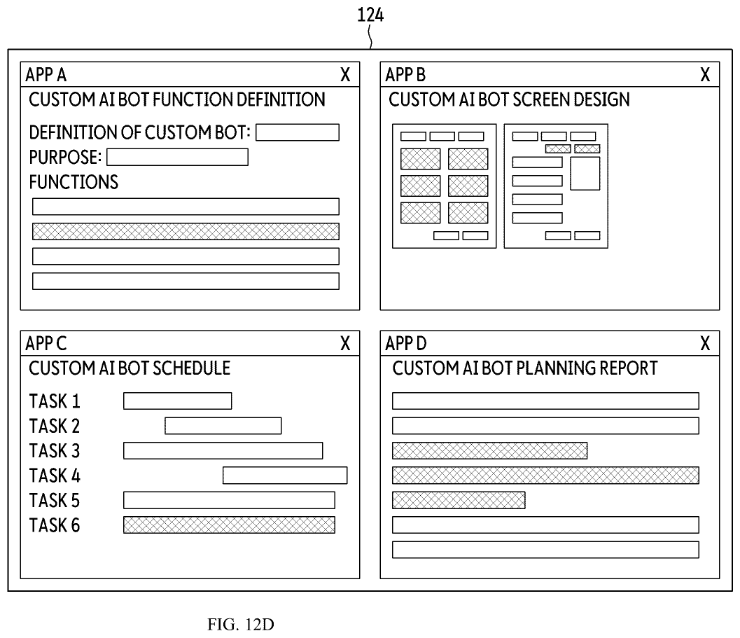

FIGS. 12A-12D are exemplary diagrams for describing some operations illustrated in FIG. 11.

First, FIG. 12A and FIG. 12B illustrate a situation in which four users perform product and service planning tasks. A plurality of users may input prompts into a user interface 121 provided by the system 10 for processing the task through the respective user terminals, and as illustrated in FIG. 12A and FIG. 12B, the prompts input into the user interface 121 and responses thereto may be provided to a plurality of user terminals.

In an example of FIG. 12A and FIG. 12B, when a user inputs a user input for a target task related to drafting a product plan, information about a task required to perform the target task and a corresponding applications may be provided based on the user input, and the result (content) 122 of the task performed through the application may be provided.

As illustrated in FIG. 12C and FIG. 12D, a plurality of users may check the result (content) through the user terminals, and may immediately check a modified result (content) (124) based on a modification request, when a prompt that requests modification for content generated through any one of the plurality of user terminals (123).

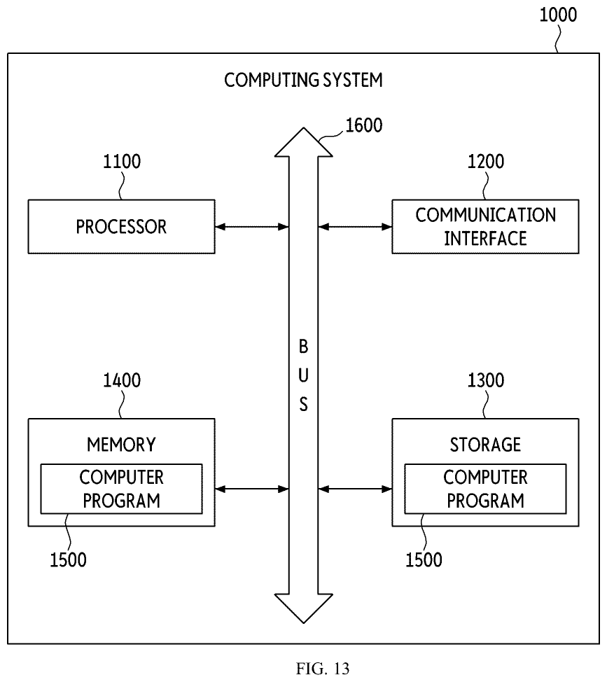

FIG. 13 is a block diagram illustrating a hardware configuration of a computing system for performing the method for processing the task based on the generative AI according to some embodiments of the present disclosure.

Referring to FIG. 13, a computing system 1000 may include one or more processors 1100, a system bus 1600, a communication interface 1200, a memory 1400 for loading a computer program 1500 executed by the processor 1100, and a storage 1300 for storing the computer program 1500. However, only the components related to the embodiments of the present disclosure are illustrated in FIG. 11. Therefore, those skilled in the art to which the present disclosure pertains may see that other general-purpose components other than the components illustrated in FIG. 13 may be further included. That is, the computing system 1000 may further include various components other than the components illustrated in FIG. 13. In addition, in some cases, the computing system 1000 may also be configured in a form in which some of the components illustrated in FIG. 13 are omitted. Hereinafter, each component of the computing system 1000 will be described.

The processor 1100 may control an overall operation of each component of the computing system 1000. The processor 1100 may be configured to include at least one of a central processing unit (CPU), a micro processor unit (MPU), a micro controller unit (MCU), a graphic processing unit (GPU), or any type of processor well known in the art. In addition, the processor 1100 may perform a calculation on at least one application or program for executing the specific steps/operations/methods. The computing device 1000 may include one or more processors.

Next, the memory 1400 stores various data, commands, and/or information. The memory 1400 may load the computer program 1500 from the storage 1300 to execute the operations/methods according to the embodiments of the present disclosure. The memory 1400 may be implemented as a volatile memory such as RAM, but the technical scope of the present disclosure is not limited thereto.

Next, the bus 1600 may provide a communications function between the components of the computing system 1000. The bus 1600 may be implemented as various types of buses, such as an address bus, a data bus, and a control bus.

Next, the communication interface 1200 supports wired/wireless Internet communications of the computing system 1000. In addition, the communication interface 1200 may also support various communication methods other than Internet communications. To this end, the communication interface 1200 may include a communication module well known in the art of the present disclosure.

Next, the storage 1300 may non-temporarily store one or more computer programs 1500. The storage 1300 may include a non-volatile memory such as a read only memory (ROM), an erasable programmable ROM (EPROM), an electrically erasable programmable ROM (EEPROM), a flash memory, or the like, a hard disk, a removable disk, or any form of computer-readable recording medium well known in the art to which the present disclosure pertains.

Next, the computer program 1500 may include one or more instructions that when loaded into the memory 1400, cause the processor 1100 to perform the specific steps/operations/methods. That is, the processor 1100 may perform the specific steps/operations/methods by executing the one or more instructions.

For example, the computer program 1500 may include instructions for operations of: receiving a user request regarding a target task from a user terminal, determining a task set required to process the target task by inputting the user request into a generative model, the task set including a plurality of tasks performed through a plurality of applications, requesting a corresponding task to be performed for each of the plurality of applications, and providing a plurality of contents generated through each of the plurality of applications to the user terminal according to the task performance request.

In some embodiments, the computing system 1000 illustrated in FIG. 13 may also refer to a virtual machine implemented based on cloud technology. For example, the computing system 1000 may be a virtual machine operating on one or more physical servers included in a server farm. In this case, at least some of the processor 1100, the memory 1400, and the storage 1300 illustrated in FIG. 13 may be virtual hardware, and the communication interface 1200 may also be implemented as a virtualized networking element such as a virtual switch.

Various embodiments of the present disclosure and effects according to the embodiments have been mentioned with reference to FIGS. 1 to 11. The effects according to the technical spirits of the present disclosure are not limited to the above-mentioned effects, and other effects not mentioned will be clearly understood by those skilled in the art from the following description.

Furthermore, although a plurality of components have been described as being combined into one or operated in combination in the above embodiments, the technical spirits of the present disclosure are not necessarily limited thereto. That is, all of the components may operate to be selectively combined in one or more within the purpose scope of the technical spirits of the present disclosure.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for processing a task based generative AI, performed by at least one computing system, the method comprising:
receiving a user request regarding a target task from a user terminal;
determining a task set required to process the target task by inputting the user request into a generative model, the task set including a plurality of tasks performed through a plurality of applications;
requesting a corresponding task to be performed for each of the plurality of applications; and
providing a plurality of contents generated through each of the plurality of applications to the user terminal according to the task performance request.

2. The method of claim 1, wherein the determining of the task set includes:
obtaining context information associated with the user request;
configuring a prompt for determining the task set based on the user request and the context information; and
determining the task set by inputting the prompt into the generative model.

3. The method of claim 2, wherein the context information includes task history information associated with a user of the user terminal.

4. The method of claim 2, wherein the context information includes information about an activated application in the user terminal.

5. The method of claim 1, wherein the requesting of the corresponding task to be performed includes:
generating a task performance request message for each of the plurality of tasks; and
transmitting the task performance request message to a corresponding application.

6. The method of claim 1, wherein the requesting of the corresponding task to be performed includes:
determining a task performance order based on a correlation between the plurality of tasks;
sequentially generating a task performance request message based on the task performance order; and
sequentially transmitting the task performance request message to a corresponding application.

7. The method of claim 6, wherein the generating of the task performance request message includes:
generating a first task performance request message for a first application; and
generating a second task performance request message for a second application using a first content generated through the first application based on the first task performance request message.

8. The method of claim 1, wherein the requesting of the corresponding task to be performed includes:
providing information about the determined task set to the user terminal; and
requesting a corresponding task to be performed for each of the plurality of applications to perform a corresponding task, when a request to proceed with the task set is received from the user terminal.

9. The method of claim 1, wherein the providing of the plurality of contents to the user terminal further includes:
receiving a modification request for at least one of the plurality of contents from the user terminal;
transmitting a modification request message for performing a modification task according to the modification request to an application associated with the modification request; and
providing modified content to the user terminal based on the modification request message.

10. A method for processing a task based generative AI, performed by at least one computing system, the method comprising:
receiving a plurality of user requests regarding a target task from a plurality of user terminals corresponding to each of a plurality of users of a user group for performing a joint task;
determining a task set for performing the target task based on the plurality of user requests, the task set including a plurality of tasks performed through a plurality of applications;
requesting a corresponding task to be performed for each of the plurality of applications; and
providing a plurality of contents generated from each of the plurality of applications based on the task performance request to each of the plurality of user terminals.

11. The method of claim 10, wherein the plurality of user terminals include a first user terminal, and
the receiving of the plurality of user requests includes:
receiving a first user request from the first user terminal; and
transmitting the first user request to remaining user terminals except for the first user terminal.

12. The method of claim 10, wherein the receiving of the plurality of user requests includes:
checking user authentication information corresponding to the plurality of user terminals; and
determining whether to receive the plurality of user requests based on the check result.

13. The method of claim 10, wherein the determining of the task set includes:
obtaining context information associated with the plurality of user requests;
configuring a prompt for determining the task set based on the plurality of user requests and the context information; and
determining the task set by inputting the prompt into the generative model.

14. A system for processing a task based on generative AI, the system comprising:
one or more processors; and
a memory configured to store one or more computer programs executed by the one or more processors,
wherein the one or more computer programs include instructions for:
an operation of receiving a user request regarding a target task from a user terminal;
an operation of determining a task set required to process the target task by inputting the user request into a generative model, the task set including a plurality of tasks performed through a plurality of applications;
an operation of requesting a corresponding task to be performed for each of the plurality of applications; and
an operation of providing a plurality of contents generated through each of the plurality of applications to the user terminal according to the task performance request.

15. The system of claim 14, wherein the operation of determining the task set includes:
an operation of obtaining context information associated with the user request;
an operation of configuring a prompt for determining the task set based on the user request and the context information; and
an operation of determining the task set by inputting the prompt into the generative model.

16. The system of claim 14, wherein the operation of requesting the corresponding task to be performed includes:
an operation of generating a task performance request message for each of the plurality of tasks; and
an operation of transmitting the task performance request message to a corresponding application.

17. The system of claim 14, wherein the operation of requesting the corresponding task to be performed includes:
an operation of determining a task performance order based on a correlation between the plurality of tasks;
an operation of sequentially generating a task performance request message based on the task performance order; and
an operation of sequentially transmitting the task performance request message to a corresponding application.

18. The system of claim 17, wherein the operation of generating the task performance request message includes:
an operation of generating a first task performance request message for a first application; and
an operation of generating a second task performance request message for a second application using a first content generated through the first application based on the first task performance request message.

19. The system of claim 14, wherein the operation of requesting the corresponding task to be performed includes:
an operation of providing information about the determined task set to the user terminal; and
an operation of requesting a corresponding task to be performed for each of the plurality of applications to perform a corresponding task, when a request to proceed with the task set is received from the user terminal.

20 The system of claim 14, wherein the operation of providing the plurality of contents to the user terminal further includes:
an operation of receiving a modification request for at least one of the plurality of contents from the user terminal;
an operation of transmitting a modification request message for performing a modification task according to the modification request to an application associated with the modification request; and
an operation of providing modified content to the user terminal based on the modification request message.
